(19) United States
(12) Patent Application Publication
(10) Pub. No.: US 2013/0256314 A1
(43) Pub. Date: Oct. 3, 2013

(54) WASTE COLLECTING DEVICE

(71) Applicant: Pierre Marconi, Shanghai (CN)

(72) Inventor: Pierre Marconi, Shanghai (CN)

(21) Appl. No.: 13/991,865

(22) PCT Filed: Nov. 14, 2011
(86) PCT No.: PCT/EP2011/005724

§ 371 Date: Jun. 5, 2013

(30) Foreign Application Priority Data
Dec. 6, 2010 (FR) 10/04744

(51) Int. Cl. B65F 1/06

(52) U.S. Cl. CPC B65F 1/067
USPC 220/495.09

(57) ABSTRACT

Waste collecting device including a base (10), an intermediate body (2) having a disk (30) for carrying three bags and having three openings for the passage of waste into the bags, a first cylinder or rod (34) arranged to slide along a second cylinder or rod (35) mounted on the base (10) so as to set the height of the intermediate body, and a cover (3) made of upper and lower elements (50,70), having a circular shape and pivotable around a horizontal axis. Both upper and lower elements include a half jaw which cooperate to crush and reduce the volume of waste items. Upper element (70) has an opening for the passage of glass bottles. Lower element (50) has a set of openings (51, 52, 53, 54, 55) arranged for the passage of waste items into a determined number of compartments and into the three bags.

### TECHNICAL FIELD

The present invention relates to a household waste sorting and stocking device capable of collecting the great variety of waste produced by a family household.

### BACKGROUND ART

Everyone is aware of the great quantity of domestic waste which can be produced by a family.

So far, such domestic waste should be properly collected and sorted in order to be properly treated.

Nowadays, consumers are becoming more and more concerned with such issue and the authorities are trying to develop a real environmental protection policy.

Even if sorting, collecting and treating household waste mainly depend on public authorities, every single individual can participate.

And this starts when someone throws an object or a packing in the trash can . . . .

Various types of “green” collecting devices or garbage cans are available on the market.

Those ones, composed of 2 or 3 compartments, in a cylindrical or rectangular shape, are 60 cm height in order to take out the trash bags more easily.

Some garbage cans have a tool enabling to compress the waste, in order to reduce its volume. However, most of the time, using it shows to be difficult and unhygienic.

Moreover, and this shows to be a drawback for a clear environmental policy, because of the large packaging accompanying them, the known garbage cans are sold at high shipping costs, being up to 30% of the final price.

Besides, their aging conception does not consider the new environmental issues, such as:
the need to preserve the planet and its resources.
the need to reduce dramatically the volume and the weight for the shipping and logistics.
the need to sort and collect the new household waste: filter of the jug, plastic cap, plastic capsule, coffee pod.
the need to sort and collect the electronical waste particularly polluting: batteries, bulbs, printer cartridges.

Those garbage cans are not convenient for collecting, sorting and storing those new mass market products.

Then, there is the issue of transporting the waste to the right garbage collector.

The journey can be very variable, from 10 meters when a garbage collector is closely available to a distance being such that a car might be needed so as to convey, for instance, glass waste to the appropriate collectors which might be at a far location.

This journey becomes really important when we deal with electronical waste (batteries, bulbs . . . ) and particular household waste (filter of the jug, coffee pod . . . ). Indeed, they are collected in specialized stores or hypermarkets which might be very far from home.

One also notice the rise of new ways of collecting waste with the development of particular charities that deal more with charitable goals than ecological ones. Some city stores have arranged the possibility to collect plastic corks e.g. for wine bottles, screwcorks . . .

Then appears the issue of how to transport—safely with minimum exposure to hurt—those waste to the place they are collected in a safe (for glass and bulbs) and clean (coffee pod, filter of the jug) way.

We already know some types of garbage cans aiming to improve the house waste sorting:

Patent WO2005092743 describes a recipient which contain a compactor under the cover.

Patent WO2008038317 describes a mechanism which is inside the cover and made up of a lever, stud-type track roller and a pantograph system.

Patent FR2687132 describes a sorting device which can compact household waste. It is described a set of 2 covers interconnected by a central articulation. One of them carries a spring compactor.

Patent FR2930751 describes a trolley with a gripping mean, a hollow compartment and a compacting device with two rigid plates.

Patents GB2315404, EP 2014582 and U.S. Pat. No. 7,237,480 B2 describe a container that includes a main body, a cover that can be associated with the main body and a compactor fitted with a pressure element, moving into the main body to compact the waste.

Patent EP 1724215 describes a content for the collecting of the waste.

Patent WO9402387 is about a modular garbage can which includes several elements open on top, of equal height, configured to fit with one another and maintain in a block on wheels.

Patent WO2007000791 describes a domestic garbage can for a separated collect of waste with several garbage cans onto one another.

Patent EP 0771743: the invention is about a waste container with a pivoting round cover.

All those solutions certainly show some advantages, but do not permit the compression, the stocking and the transportation of household waste in a convenient, economical and safe way with a garbage can requiring few raw material and reducing the logistic costs.

That is the issue we aim to solve with this invention.

### SUMMARY OF THE INVENTION

It is an object of the present invention to carry out a household waste sorting and stocking device capable of collecting the great variety of waste produced by a family.

It is another object of the present invention to achieve volume reduction of the waste thanks to the compression of the packaging.

It is a third object of the present invention to facilitate transportation and collecting of the waste to their specific containers easier, without exposing the users to any wound.

It is a fourth object of the present invention to carry out a garbage collector which is easy to manufacture and more easy to ship from the manufacturing plant to the consumer household, with a clear wish to reduce logistic and shipping costs.

The invention achieves those objects by means of a waste collecting device comprising:

a base;

an intermediate body for carrying three hanging bags.

a cover comprising two upper and a lower elements, respectively and both of circular shape and which can pivot around a horizontal axis, both upper and lower elements comprising a half jaw cooperating together for crushing and reducing the volume of certain waste items.

The upper element has at least one opening for the passage of glass bottles and the lower element of the cover comprises a set of openings arranged for the passage of waste items in a determined number of compartments or recipients, all being removable.

The intermediate body includes a disk for hanging bags, the disk comprising openings for the passage of the waste up to the collection in the bags.

The intermediate body further comprises a first cylinder or rod arranged to slide along a second cylinder or rod so as to set the height of the intermediate body and fixing means for fixing the whole once the appropriate height is achieved.

In one particular embodiment, the waste collecting device includes, separated by a angle of 60 degree, three rods or cables for reinforcing the structure and on which a covering may be fixed.

Preferably, the upper element comprises a trap door and the lower element of the cover comprises a first opening or passage corresponding to the trap door allowing the glass bottles to go to the first hanging bag even when said upper element of the cover is down.

Preferably, the lower element of the cover comprises a second opening enabling the waste to go to a second hanging bag when said upper element is up.

Preferably, the lower element of the cover comprises a third opening or passage enabling the waste to go to a third hanging bag, when said upper element is up.

In one particular embodiment, the upper element comprises two reliefs matching with two openings of the lower element so as to achieve tightness.

In one particular embodiment, the lower element of the cover comprises two additional openings or holes arranged to cooperate with two removable compartments located beneath the lower element.

Preferably, the comprises a pedal mechanism located in a semi-spherical housing which also serves for guiding the swifel of one compartment.

All the recipients are removable from the device. The transportation to the containers is easier because it can be separated and individualized.

### DESCRIPTION OF THE DRAWINGS

Other characteristics, goals and advantages of the invention will appear when reading the description and the drawings, given as examples which are not restrictive. On the annexed drawings:

The FIG. 1 illustrates one embodiment of the invention.

FIG. 2 represents the device shown in the FIG. 1 with the cover up and the three hanging bags.

FIG. 3 illustrates the device of the FIG. 1 without the bags.

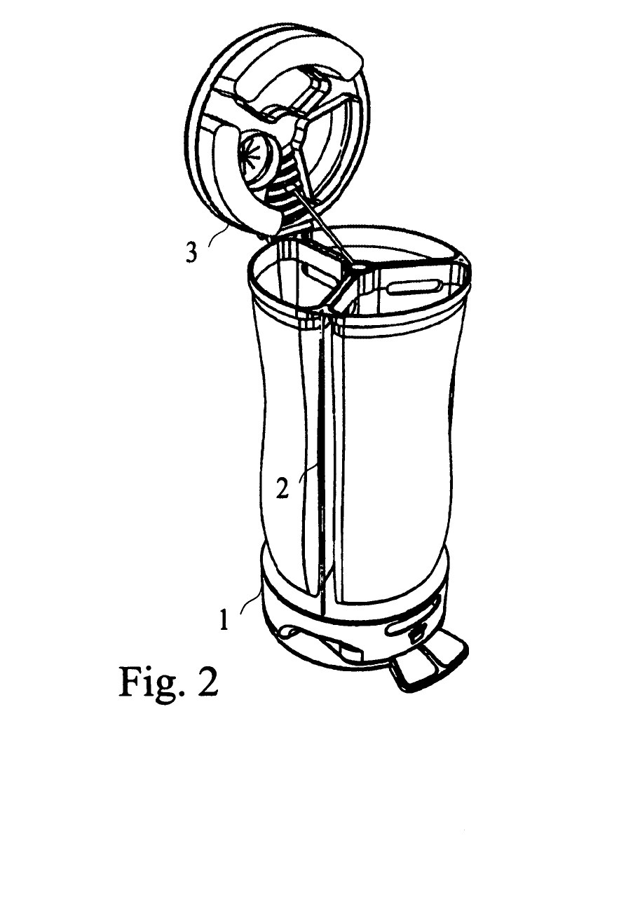

FIG. 4 illustrates the device as it appears when it is being unpacked.

FIG. 5 illustrates the different steps to assemble the device.

FIG. 6 illustrates the device with its cover and its lower recipient open.

FIG. 6b illustrates the structure of the lower recipient.

FIG. 7 illustrates three perspective views of a second embodiment, with the addition of an interchangeable covering in a oilcloth type.

FIG. 8 illustrates three perspective views of a third embodiment, with the addition of an interchangeable covering in a metallic type.

### DESCRIPTION OF ONE PREFERRED EMBODIMENT

After the Grenelle Environment, an ambitious waste management policy has been set up in order to reduce the production of household waste and so by 7% in 5 years. In the area of recycling material and household waste, the target figure is 35% in 2012 and 45% in 2015, against 24% in 2004. This policy targets a packaging recycling of 75% in 2012 (against 60% in 2006) together with waste of the firms. By the year 2012, waste meant to go to landfill or incineration are expected to decrease by 15%.

In view of those ambitious goals, garbage cans being able to: sort, compact, stock and transport, should be made available for households.

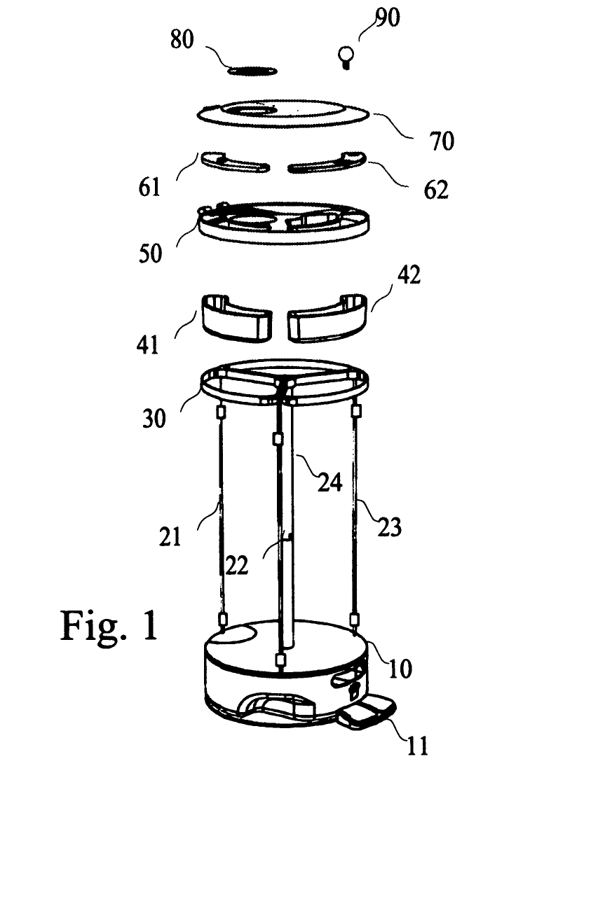

FIGS. 1 and 2 illustrate one embodiment of the invention.

As we can see it on the FIG. 2, the garbage can is made of 3 different parts, easily detachable in order to make transportation and logistics easier:

A base (1)
An intermediate structure (2) which maintain three hanged bags.
A cover (3)

The FIG. 1 enables to show more in depth the details of the trash can.

As we can see in the FIG. 1, the cover is made of two elements 70 and 50, respectively upper and lower and both in a circular form, being able to pivot around a horizontal axis. The upper element 70 comprises at least one aperture for glass bottles. Preferably, the upper element 70 has a handle 90 as well as a trap door enabling to hide the hole when it is not being used.

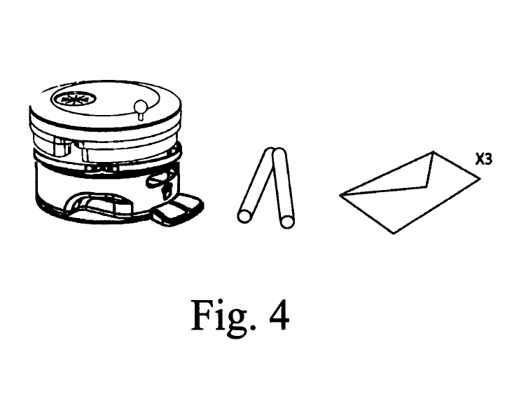

The lower element 50 of the cover includes different openings or holes 51, 52, 53, 54 and 55, as shown in FIG. 5, enable the waste to go in the right recipient or compartment.

A first opening 51 corresponding to the trap door 80 enables to throw the glass bottles into a first hanging bag. Doing that is still possible even when the upper element 70 of the cover is down.

A second opening 52 enables to throw the packaging into a second hanging bag, the upper element 70 of the cover has to be up to do this.

A third opening or hole 53 enables to throw organic waste into a third hanging bag, the upper element 70 of the cover has to be up to do this.

In order to preserve the tightness (especially to the smell), the upper element 70 of the cover has two reliefs which match perfectly with the two openings 52 and 53 of the lower part in order to warrant the tightness.

The lower element 50 further comprises, as shown in the embodiment of FIG. 2 (and also in that of FIG. 5), two additional openings 54 and 55 arranged to cooperate with two separated removable recipients 41 and 42 placed under element 50.

The two recipients or collectors 41 and 42 are used to collect batteries, coffee pods . . . waiting to be transported to their containers.

In one particular embodiment, each of the recipients or collector 41 and 42 has a specific cover (respectively 61 and 62) enabling to protect and isolate the content until the latter is being transported to the containers.

As we can see in the FIG. 5, on each of the upper and lower elements 70 and 50 there is a half jaw cooperating with one another to crush and to reduce the volume of certain objects. We can reduce dramatically the volume of the plastic bottles, packaging and cans . . .

The device further includes an intermediate structure, with bearing capacity, with a disc 30 having itself three openings or holes 31, 32 and 33, respectively intended for each waste bag. On the axis of disc 30, a first cylinder 34 is located and made to slide with a second cylinder 35 (with a diameter slightly higher or lower) in order to adjust the height of the intermediate structure and to be able to compress and use it right at the proper height. The final positioning can be locked by means of adequate means: screws, spacers etc. . . .

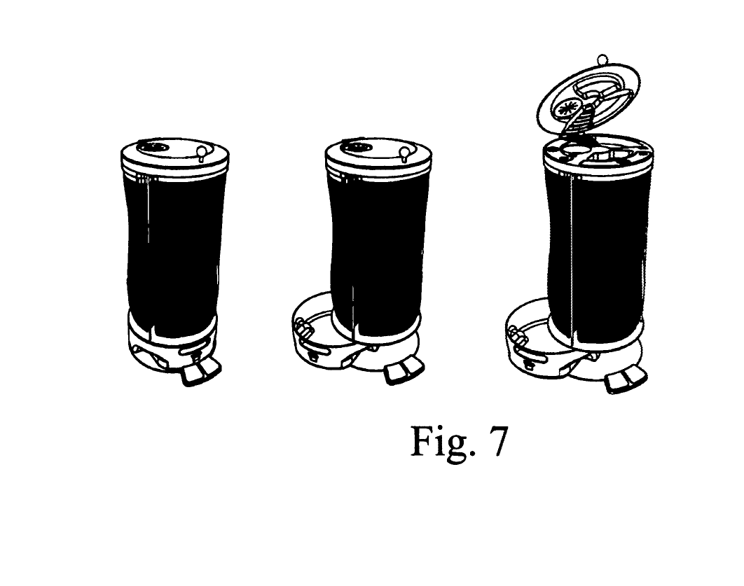

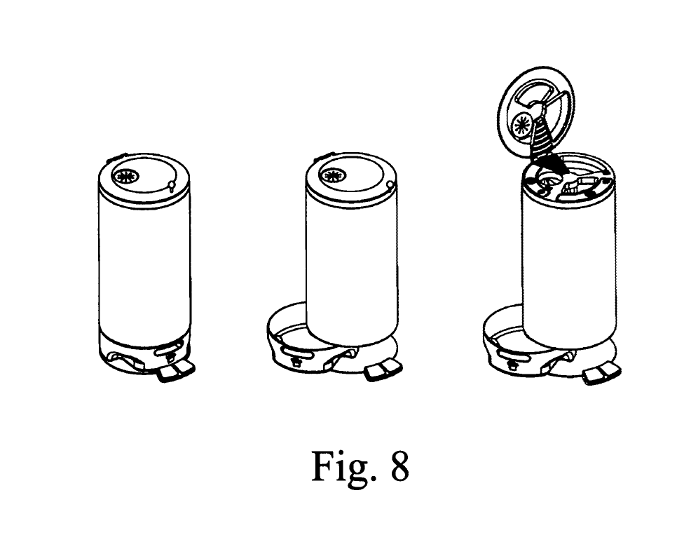

Moreover, on the disc 30 are fixed three rods or cables 21, 22 and 23 (shown in FIG. 1), located on positions on a circumference which are separated by angles of 60 degrees, so as to increase the rigidity of the structure and, moreover, to support the covering of the collector which can be based on plastic or oilcloth, or even a metal foil as illustrated in FIGS. 7 and 8.

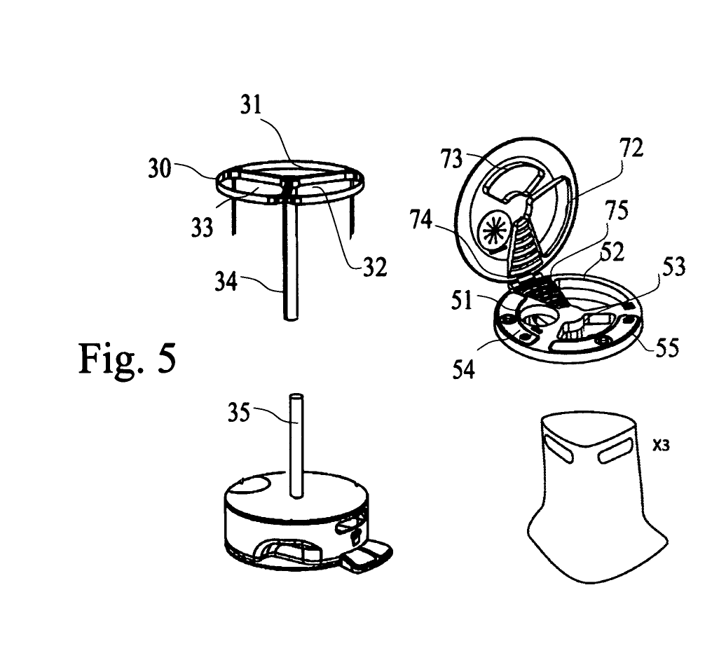

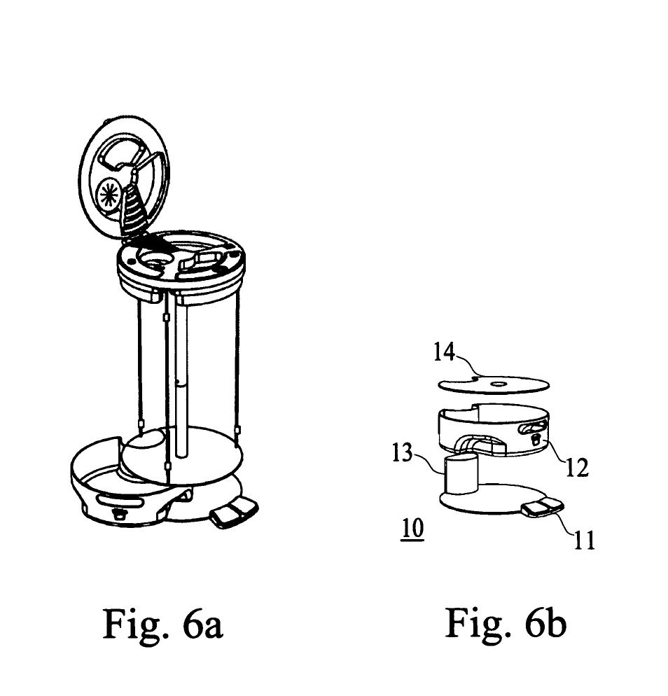

In addition to the upper part which has been described above, the garbage collector further includes a lower part with a base 10, as shown in the disassembled view in the FIG. 6b, which has a pedal mechanism lodged in a demos-spherical volume 13, being also used for the recipients 12 to pivot and collect newspapers or . . . with its own cover 14.

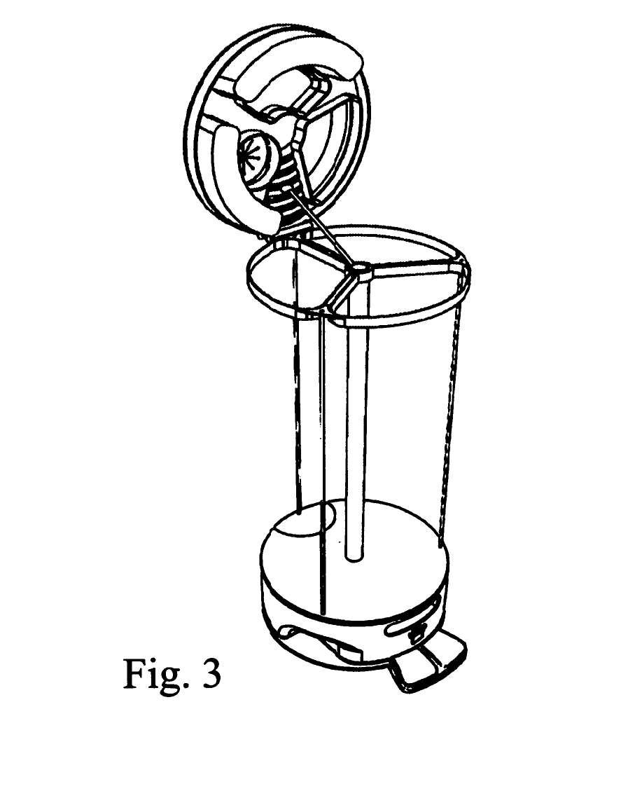

The device is easily demountable and facilitates the transportation to the containers. The FIG. 4 illustrates the device as it appears when it is being unpacked. It takes really small space.

1. Waste collecting device comprising:
a base (1)
an intermediate body (2) for carrying three hanged bags
a cover (3) comprising two upper and a lower elements (50, 70), respectively, both of circular shape and which can pivot around a horizontal axis, both upper and lower elements comprising a half jaw cooperating together for crushing and reducing the volume of certain waste items;
said upper element (70) having at least one opening for the passage of glass bottles;
said lower element (50) of said cover comprising a set of openings (51, 52, 53, 54, 55) arranged for the passage of waste items in a determined number of compartments or recipients;
said intermediate body (2) comprising a disk (30) on which can be hung bags, said disk (30) comprising openings for the passage of the waste up to the collection in said bags, said intermediate body further comprising a first cylinder or rod (34) arranged to slide along a second cylinder or rod (35) so as to set the height of the intermediate body and fixing means for fixing the whole once the appropriate height is achieved.

2. Waste collecting device according to claim 1 further comprising, separated by a angle of 60 degree, three rods or cables (21, 22, 23) for reinforcing the structure and supporting a covering.

3. Waste collecting device according to claim 1, wherein said upper element comprises a trap door (80) and said lower element of the cover comprises a first opening or passage (51) corresponding to said trap door allowing the glass bottles to go to the first hanged bag even when said upper element of the cover is down (70).

4. Waste collecting device according to claim 3 wherein said lower element of the cover comprises a second opening (52) enabling the waste to go to a second hanged bag when said upper element is up.

5. Waste collecting device according to claim 4 wherein said lower element of the cover comprises a third opening or passage (53) enabling the waste to go to a third hanged bag, when said upper element (70) is up.

6. Waste collecting device according to claim 5 wherein said upper element (70) comprises two reliefs (72, 73) matching with two openings of the lower element (52, 53) in order to achieve tightness.

7. Waste collecting device according to claim 6 wherein said lower element of the cover comprises two additional openings or holes (54, 55) arranged to cooperate with two removable compartments (41, 42) located beneath the lower element (50).

8. Waste collecting device according to claim 1, wherein the base comprises a pedal mechanism located in a semi-spherical housing (13) which also serves for guiding the swivel of one compartment (12).

9. Waste collecting device according to claim 1 further comprising removable coverings arranged to be fixed on the rods or cables of the intermediate body.

10. Waste collecting device according to claim 1, wherein said intermediate body carries at least two bags.
